(19) United States
(12) Patent Application Publication
(10) Pub. No.: US 2017/0141624 A1
(43) Pub. Date: May 18, 2017

(54) DEVICES AND METHODS FOR ADJUSTING WIRELESS RECEIVER POWER DEMAND

(71) Applicant: QUALCOMM Incorporated, San Diego, CA (US)

(72) Inventor: Mark White, II, Solana Beach, CA (US)

(21) Appl. No.: 15/135,443

(22) Filed: Apr. 21, 2016

Related U.S. Application Data
(60) Provisional application No. 62/254,975, filed on Nov. 13, 2015.

(51) Int. Cl. H02J 50/80; H02J 7/02; H02J 50/12

(52) U.S. Cl. CPC H02J 50/80; H02J 50/12; H02J 7/025

(57) ABSTRACT

Methods and apparatus are disclosed for wirelessly receiving power. In one aspect, an apparatus for wirelessly transmitting power to power or charge a wireless power receiver is provided. The apparatus comprises a transmitter circuit configured to transmit wireless power via a magnetic field sufficient to power or charge a load. The apparatus further includes a processor circuit configured to determine a power level capability of the transmitter circuit. The apparatus further includes a communication transceiver circuit configured to transmit a first communication to the wireless power receiver, the first communication including a request to adjust a power demand from a first power level to a second power level, the first power level being higher than the second power level. The second power level is commensurate with the power level capability of the transmitter circuit

### CROSS REFERENCE TO RELATED APPLICATION(S)

This application claims priority benefit under 35 U.S.C. §119(e) to U.S. Provisional Patent Application No. 62/254,975 entitled “DEVICES AND METHODS FOR ADJUSTING WIRELESS RECEIVER POWER DEMAND” filed on Nov. 13, 2015, the disclosure of which is hereby incorporated by reference in its entirety.

### FIELD

This application is generally related to wireless power charging of chargeable devices. More particularly, the application relates to devices and methods for adjusting wireless receiver power demand based on the power supply capabilities of a wireless power transmitter.

### BACKGROUND

An increasing number and variety of electronic devices are powered via rechargeable batteries. Such devices include mobile phones, portable music players, laptop computers, tablet computers, computer peripheral devices, communication devices (e.g., Bluetooth devices), digital cameras, hearing aids, and the like. While battery technology has improved, battery-powered electronic devices increasingly require and consume greater amounts of power, thereby often requiring recharging. Rechargeable devices are often charged via wired connections through cables or other similar connectors that are physically connected to a power supply. Cables and similar connectors may sometimes be inconvenient or cumbersome and have other drawbacks. Wireless charging systems that are capable of transferring power in free space to be used to charge rechargeable electronic devices or provide power to electronic devices may overcome some of the deficiencies of wired charging solutions. As such, wireless power transfer systems and methods that efficiently and safely transfer power to electronic devices are desirable.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the present disclosure provides an apparatus for wirelessly transmitting power to power or charge a wireless power receiver. In some embodiments, the apparatus comprises a transmitter circuit configured to transmit wireless power via a magnetic field sufficient to power or charge the wireless power receiver. The apparatus may further comprise a processor circuit configured to determine a power level capability of the transmitter circuit. The apparatus may further comprise a communication circuit configured to transmit a first communication to the wireless power receiver. The first communication may include a request to adjust a power demand of the wireless power receiver from a first power level to a second power level. The first power level may be higher than the second power level. In some aspects, the second power level is commensurate with the power level capability of the transmitter circuit.

In some embodiments, the power level capability may be based on to a power supply capability of a power source coupled to the transmitter circuit. In such embodiments, the apparatus may further comprise a sensor circuit configured to determine whether the power source is capable of providing the first power level or the second power level. In some embodiments, the communication circuit may further be configured to receive a second communication from the wireless power receiver, the second communication including the power demand at the first power level. In some embodiments, the communication circuit may further be configured to transmit the first communication when the power level capability corresponds to a power level below the first power level. In some embodiments, the second power level may correspond to a power level equal to or below the power level capability of the transmitter circuit. And in some embodiments, the processor circuit may further be configured to adjust a current level of the transmitter circuit based on the power level capability of the transmitter circuit.

Other aspects of the present disclosure provide for an apparatus according to any of the embodiments described herein or in the figures. Other aspects of the present disclosure provide for a method according to any of the embodiments described herein or in the figures.

### BRIEF DESCRIPTION OF THE DRAWINGS

FIG. 1 is a functional block diagram of an exemplary wireless power transfer system, in accordance with exemplary embodiments of the application.

FIG. 2 is a functional block diagram of exemplary components that may be used in the wireless power transfer system of FIG. 1, in accordance with various exemplary embodiments of the application.

FIG. 3 is a schematic diagram of a portion of transmit circuitry or receive circuitry of FIG. 2, in accordance with exemplary embodiments of the application.

FIG. 4 is a diagram of an exemplary wireless power transfer system, in accordance with exemplary embodiments of the application.

FIG. 5 is a functional block diagram of a wireless power transfer system, in accordance with one implementation as used in the system of FIG. 4.

FIG. 6 is an exemplary flow diagram among a power source, a power transmitting unit (PTU), and a power receiving unit (PRU).

FIG. 7 is a flowchart of an exemplary method of receiving wireless power, in accordance with the disclosure herein.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples, alone or in combination with other features described below, and may further include modifications and equivalents of the features and concepts described herein.

Wireless power transfer may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field or an electromagnetic field) may be received, captured by, or coupled by a “power receiving element” to achieve power transfer.

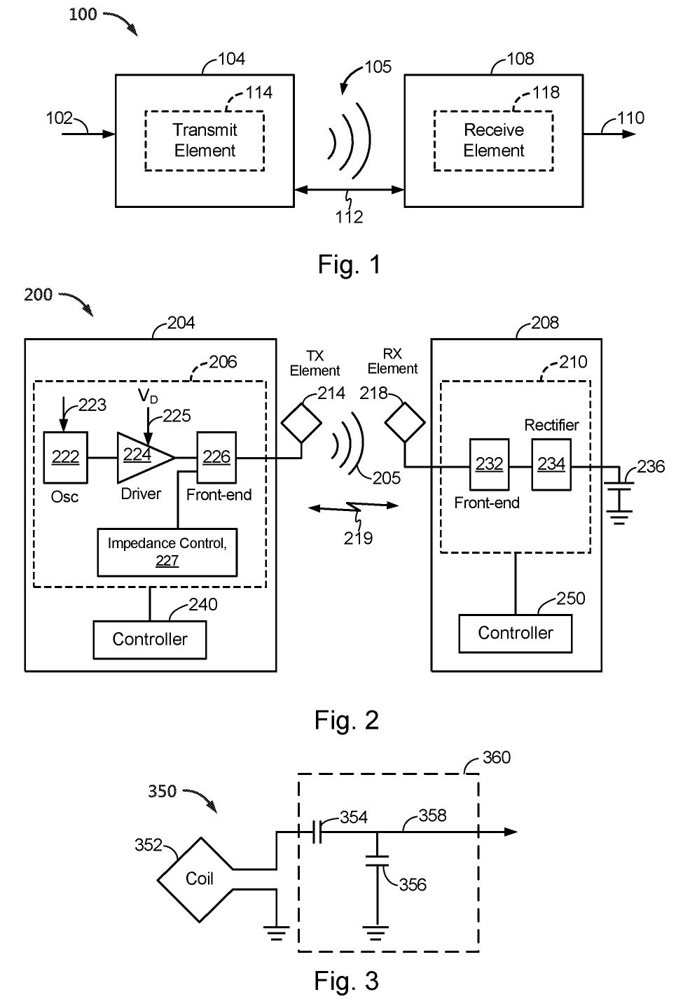

FIG. 1 is a functional block diagram of a wireless power transfer system 100, in accordance with an illustrative embodiment. Input power 102 may be provided to a transmitter circuit 104 from a power source (not shown in this figure) to generate a wireless (e.g., magnetic or electromagnetic) field 105 for performing energy transfer. A receiver circuit 108 may couple to the wireless field 105 and generate output power 110 for storing or consumption by a device (not shown in this figure) coupled to the output power 110. The transmitter 104 and the receiver 108 may be separated by a distance 112. The transmitter 104 may include a power transmitting element circuit 114 for transmitting/coupling energy to the receiver 108. The receiver 108 may include a power receiving element circuit 118 for receiving or capturing/coupling energy transmitted from the transmitter 104.

In one illustrative embodiment, the transmitter 104 and the receiver 108 may be configured according to a mutual resonant relationship. When the resonant frequency of the receiver 108 and the resonant frequency of the transmitter 104 are substantially the same or very close, transmission losses between the transmitter 104 and the receiver 108 are reduced. As such, wireless power transfer may be provided over larger distances. Resonant inductive coupling techniques may thus allow for improved efficiency and power transfer over various distances and with a variety of inductive power transmitting and receiving element configurations.

In certain embodiments, the wireless field 105 may correspond to the “near field” of the transmitter 104 as will be further described below. The near-field may correspond to a region in which there are strong reactive fields resulting from the currents and charges in the power transmitting element 114 that minimally radiate power away from the power transmitting element 114. The near-field may correspond to a region that is within about one wavelength (or a fraction thereof) of the power transmitting element 114.

In certain embodiments, efficient energy transfer may occur by coupling a large portion of the energy in the wireless field 105 to the power receiving element 118 rather than propagating most of the energy in an electromagnetic wave to the far field.

In certain implementations, the transmitter 104 may output a time varying magnetic (or electromagnetic) field with a frequency corresponding to the resonant frequency of the power transmitting element 114. When the receiver 108 is within the wireless field 105, the time varying magnetic (or electromagnetic) field may induce a current in the power receiving element 118. As described above, if the power receiving element 118 is configured as a resonant circuit to resonate at the frequency of the power transmitting element 114, energy may be efficiently transferred. An alternating current (AC) signal induced in the power receiving element 118 may be rectified to produce a direct current (DC) signal that may be provided to charge or to power a load.

Aspects described herein relate to wireless power transfer systems. In some embodiments, a wireless power receiver (e.g., receiver 108) may request more power than a wireless power transmitter (e.g., transmitter 104) may be capable of providing. In some aspects, this may occur when the transmitter 104 is coupled to the input power 102 and the input power 102 is a low power source (e.g., USB power supply). In such aspects, it may be possible for the receiver 108 to overdraw the input power 102 which may result in the receiver 108 disconnecting from the transmitter 104 and/or the transmitter 104 shutting down. Embodiments described herein relate to adjusting the receiver 108 power demand to prevent overdrawing the input power 102 (e.g., low power or USB power supply).

FIG. 2 is a functional block diagram of a wireless power transfer system 200, in accordance with another illustrative embodiment. The system 200 may be a wireless power transfer system of similar operation and functionality as the system 100 of FIG. 1. However, the system 200 provides additional details regarding the components of the wireless power transfer system 200 than FIG. 1. The system 200 may include a transmitter circuit 204 and a receiver circuit 208. The transmitter 204 (also referred to herein as power transmitting unit, PTU) may include transmit circuitry 206 that may include an oscillator circuit 222, a driver circuit 224, a front-end circuit 226, and an impedance control module circuit 227. The oscillator 222 may be configured to generate a signal at a desired frequency that may adjust in response to a frequency control signal 223. The oscillator 222 may provide the oscillator signal to the driver circuit 224. The driver circuit 224 may be configured to drive the power transmitting element 214 at, for example, a resonant frequency of the power transmitting element 214 based on an input voltage signal (VD) 225. The driver circuit 224 may be a switching amplifier configured to receive a square wave from the oscillator 222 and output a sine wave.

The front-end circuit 226 may include a filter circuit to filter out harmonics or other unwanted frequencies. The front-end circuit 226 may include a matching circuit to match the impedance of the transmitter 204 to the power transmitting element 214. As will be explained in more detail below, the front-end circuit 226 may include a tuning circuit to create a resonant circuit with the power transmitting element 214. As a result of driving the power transmitting element 214, the power transmitting element 214 may generate a wireless field 205 to wirelessly output power at a level sufficient for charging a battery 236, or otherwise powering a load. The impedance control module circuit 227 may control the front-end circuit 226.

The transmitter 204 may further include a controller circuit 240 operably coupled to the transmit circuitry 206 configured to control one or aspects of the transmit circuitry 206 or accomplish other operations relevant to managing the transfer of power. The controller 240 may be a micro-controller or a processor. The controller 240 may be implemented as an application-specific integrated circuit (ASIC). The controller 240 may be operably connected, directly or indirectly, to each component of the transmit circuitry 206. The controller 240 may be further configured to receive information from each of the components of the transmit circuitry 206 and perform calculations based on the received information. The controller 240 may be configured to generate control signals (e.g., signal 223) for each of the components that may adjust the operation of that component. As such, the controller 240 may be configured to adjust or manage the power transfer based on a result of the operations performed by it. The transmitter 204 may further include a memory (not shown) configured to store data, for example, such as instructions for causing the controller 240 to perform particular functions, such as those related to management of wireless power transfer.

The receiver 208 (also referred to herein as power receiving unit, PRU) may include receive circuitry 210 that may include a front-end circuit 232 and a rectifier circuit 234. The front-end circuit 232 may include matching circuitry to match the impedance of the receive circuitry 210 to the power receiving element 218. As will be explained below, the front-end circuit 232 may further include a tuning circuit to create a resonant circuit with the power receiving element 218. The rectifier circuit 234 may generate a DC power output from an AC power input to charge the battery 236, as shown in FIG. 2. The receiver 208 and the transmitter 204 may additionally communicate on a separate communication channel 219 (e.g., Bluetooth, Zigbee, cellular, etc.). The receiver 208 and the transmitter 204 may alternatively communicate via in-band signaling using characteristics of the wireless field 205.

The receiver 208 may be configured to determine whether an amount of power transmitted by the transmitter 204 and received by the receiver 208 is appropriate for charging the battery 236. Transmitter 204 may be configured to generate a predominantly non-radiative field with a direct field coupling coefficient (k) for providing energy transfer. Receiver 208 may directly couple to the wireless field 205 and may generate an output power for storing or consumption by a battery (or load) 236 coupled to the output or receive circuitry 210.

The receiver 208 may further include a controller circuit 250 configured similarly to the transmit controller 240 as described above for managing one or more aspects of the wireless power receiver. The receiver 208 may further include a memory (not shown) configured to store data, for example, such as instructions for causing the controller 250 to perform particular functions, such as those related to management of wireless power transfer.

As discussed above, transmitter 204 and receiver 208 may be separated by a distance and may be configured according to a mutual resonant relationship to minimize transmission losses between the transmitter and the receiver. In some aspects, the wireless power transfer system 200 represents a more detailed view of the wireless power transfer system 100.

FIG. 3 is a schematic diagram of a portion of the transmit circuitry 206 or the receive circuitry 210 of FIG. 2, in accordance with illustrative embodiments. As illustrated in FIG. 3, transmit or receive circuitry 350 may include a power transmitting or receiving element circuit 352 and a tuning circuit 360. The power transmitting or receiving element 352 may also be referred to or be configured as an antenna or a “loop” antenna. The term “antenna” generally refers to a component that may wirelessly output or receive energy for coupling to another “antenna.” The power transmitting or receiving element 352 may also be referred to herein or be configured as a “magnetic” antenna, or an induction coil, a resonator, or a portion of a resonator. The power transmitting or receiving element 352 may also be referred to as a coil or resonator of a type that is configured to wirelessly output or receive power. As used herein, the power transmitting or receiving element 352 is an example of a “power transfer component” of a type that is configured to wirelessly output and/or receive power. The power transmitting or receiving element 352 may include an air core or a physical core such as a ferrite core (not shown in this figure).

When the power transmitting or receiving element 352 is configured as a resonant circuit or resonator with tuning circuit 360, the resonant frequency of the power transmitting or receiving element 352 may be based on the inductance and capacitance. Inductance may be simply the inductance created by a coil or other inductor forming the power transmitting or receiving element 352. Capacitance (e.g., a capacitor) may be provided by the tuning circuit 360 to create a resonant structure at a desired resonant frequency. As a non-limiting example, the tuning circuit 360 may comprise a capacitor 354 and a capacitor 356 may be added to the transmit and/or receive circuitry 350 to create a resonant circuit.

The tuning circuit 360 may include other components to form a resonant circuit with the power transmitting or receiving element 352. As another non-limiting example, the tuning circuit 360 may include a capacitor (not shown) placed in parallel between the two terminals of the circuitry 350. Still other designs are possible. In some embodiments, the tuning circuit in the front-end circuit 226 may have the same design (e.g., 360) as the tuning circuit in front-end circuit 232. In other embodiments, the front-end circuit 226 may use a tuning circuit design different than in the front-end circuit 232.

For power transmitting elements, the signal 358, with a frequency that substantially corresponds to the resonant frequency of the power transmitting or receiving element 352, may be an input to the power transmitting or receiving element 352. For power receiving elements, the signal 358, with a frequency that substantially corresponds to the resonant frequency of the power transmitting or receiving element 352, may be an output from the power transmitting or receiving element 352. Embodiments and descriptions provided herein may be applied to resonant and non-resonant implementations (e.g., resonant and non-resonant circuits for power transmitting or receiving elements and resonant and non-resonant systems). In some aspects, the transmit or receive circuitry 350 may facilitate wireless power reception or transmission at a frequency that is more efficient than wireless power reception or transmission using transmit or receive circuitry without the tuning circuit 360.

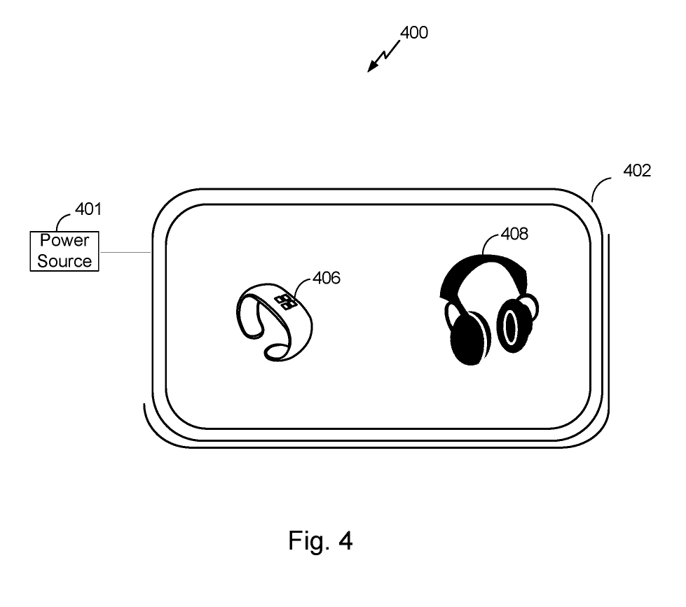

FIG. 4 is a diagram of another exemplary wireless power transfer system 400, in accordance with another illustrative embodiment. The wireless power transfer system 400 comprises a power transmitting unit (PTU) 402 coupled to a power source 401 and power receiving units (PRUs) 406 and 408. In some aspects, the power source 401 may comprise a universal series bus (USB) power source, a wall outlet, a battery, solar power, or other power source. The PTU 402 may be similar to and may comprise similar components as the transmitter 104 and/or 204 of FIGS. 1 and 2. For example, PTU 402 may comprise one or more of the power transmitting elements 114, 214, and 352 of FIGS. 1-3 and the transmit circuitry 206 of FIG. 2. Additionally, the PRUs 406 and 408 may be similar to and may comprise similar components as the receiver 108 and/or 208 of FIGS. 1 and 2. For example, PRUs 406 and 408 may comprise one or more of the power receiving elements 118, 218, and 352 of FIGS. 1-3 and the receive circuitry 210 of FIG. 2.

As shown, the PRUs 406 and 408 may be placed on a surface of or close to the PTU 402 for charging. While PRUs 406 and 408 are shown, in some aspects, the wireless power transfer system 400 may comprise a single PTU 402 and a single PRU (e.g., PRU 406). In some aspects, a PTU 402 designed to operate with a specific PRU (e.g., PRU 406) or with a type or brand of the PRU 406 may be referred to as a “dedicated PTU 402.” Likewise a PRU 406 designed to operate with a specific PTU (e.g., PTU 402) or with a type or brand of the PTU 402 may be referred to as a “dedicated PRU 406.” In some embodiments, the use of a dedicated PTU 402 and/or a dedicated PRU 406 may have the benefit of the PTU 402 and/or PRU 406 being capable of identifying certain power transfer parameters or characteristics of the respective PRU 406 and/or PTU 402. Such power transfer parameters or characteristics may be communicated between the PTU 402 and PRU 406 or may be stored in a memory of the respective devices.

In other embodiments, more than two PRUs may be placed on the surface of or close to the PTU 402 for charging the PRUs. In the embodiments of a single or dedicated PTU 402 and a single or dedicated PRU 406, the PTU 402 and PRU 406 may participate in a pairing process where certain power transfer parameters may be exchanged. For example, the PRU 406 may communicate one or more power demands with different power levels or settings to the PTU 402. In some aspects, the PTU 402 may communicate its power supply capability (e.g., 2.5 W or 5 W) or other power transfer parameters to the PRU 406. In some embodiments, the PTU 402 and PRUs 406 and 408 may communicate the power transfer parameters via a separate communication channel (e.g., communication channel 219 of FIG. 2) or via in-band signaling using characteristics of the wireless field 205 as discussed with respect to FIG. 2.

A non-limiting benefit of the wireless power transfer system 400 is that it may allow wireless power transfer from the PTU 402 to one or more devices (e.g., PRU 406 and 408). In some aspects, it may be desirable for the PRU 406 to adjust a power demand request based on the power supply capability of the PTU 402 and/or power source 401. Accordingly, a non-limiting benefit of the PTU 402 communicating its power supply capability to the PRU 406 is that the PRU 406 may adjust the power demand to satisfy the power supply capabilities of the PTU 402 and aid in reducing or eliminating overdrawing the PTU 402 and/or shutting down the wireless power transfer system 400.

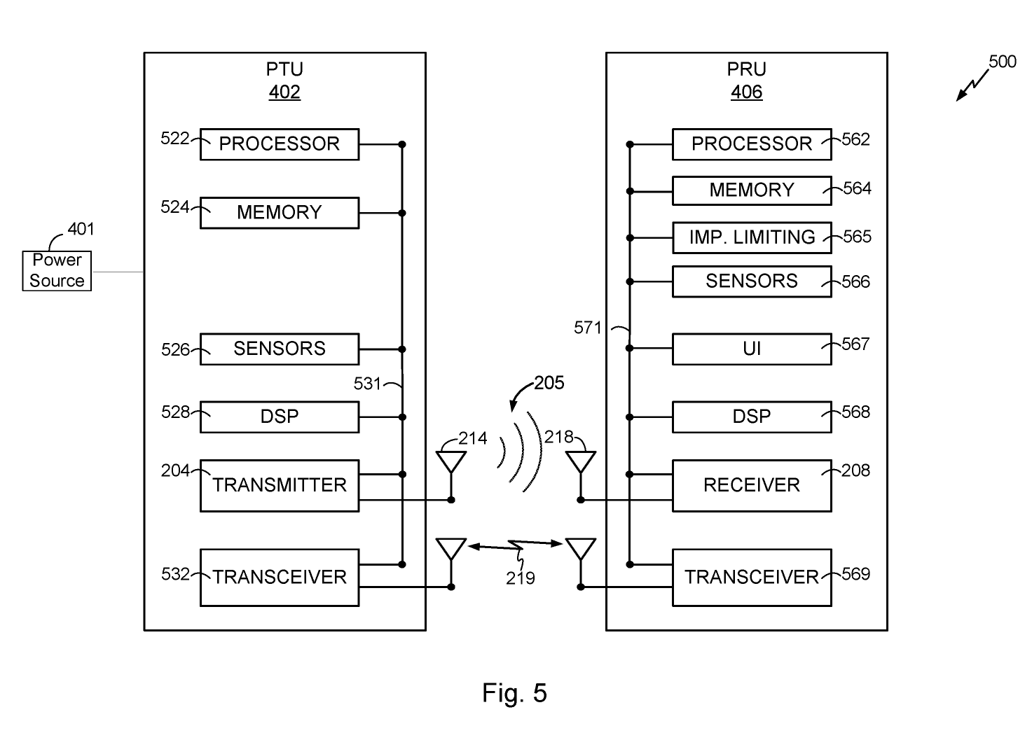

FIG. 5 shows an exemplary functional block diagram of a wireless power transfer system 500. In some aspects, the PTU 402, via the power transmitting element 214, may transfer wireless power to the power receiving element 218 of the PRU 406. As shown, the PTU 402 is coupled to the power source 401 and may utilize the processes and methods disclosed herein. In some aspects, the PTU 402 is an example of a device that may be configured to transmit wireless power using the power transmitting element 214 and via the magnetic field 205 in accordance with the descriptions of FIGS. 1-4, (above).

The PTU 402 may comprise a processor circuit 522 configured to control the operation of the PTU 402. The processor 522 may also be referred to as a central processing unit (CPU). The processor 522 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include physical machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The PTU 402 may further comprise a memory circuit 524, which may include both read-only memory (ROM) and random access memory (RAM), may provide instructions and data to the processor 522. The memory 524 may be operably coupled to the processor 522. A portion of the memory 524 may also include non-volatile random access memory (NVRAM). The processor 522 typically performs logical and arithmetic operations based on program instructions stored within the memory 524. The instructions in the memory 524 may be executable to implement the methods described herein.

The PTU 402 may further comprise one or more sensor circuits 526 operably coupled to the processor 522 and/or the memory 524 via a bus 531. The bus 531 may include a data bus, for example, as well as a power bus, a control signal bus, and a status signal bus. Those of skill in the art will appreciate that the components of the PTU 402 may be coupled together or accept or provide inputs to each other using some other mechanism.

The sensors 526 may include, but are not limited to power sensors, temperature sensors, impedance sensors, or other types of sensors. The sensors 526 may be configured to sense or detect a connection between the power source 401 and the PTU 402. In some aspects, the power source 401 supplies power to the PTU via a wired or wireless connection. The sensors 526 may detect the connection and/or an amount of power supplied by the power source 401 and communicate that information to the processor 522 via the bus 531. In other embodiments, the processor 522 may detect the connection between the power source 401 and the PTU 402 and/or the amount of power supplied. Additionally, the connection between the power source 401 and the PTU 402 and/or the amount of power supplied may be communicated to the processor 522, the sensors 526, the transceiver 532, or other component of the PTU 402. The processor 522 may determine a power level of the power supplied by the power source 401 and may set a power level flag to indicate the power level of the power source 401. In some aspects, the power level flag may be stored in the memory 524.

The PTU 402 may also include a digital signal processor (DSP) circuit 528 for use in processing signals. The DSP 528 may be configured to generate a packet for transmission.

The PTU 402 may also comprise the transmitter 204 and the power transmitting element 214 of FIG. 2 for transmission of wireless power via the wireless field 205, for reception by the PRU 406 at the power receiving element 218 (FIG. 2).

The PTU 402 may also comprise a transceiver circuit 532 allowing transmission and reception of data between the PTU 402 and the PRU 406 via the communication channel 219. In some aspects, the transceiver 532 may comprise any communication unit or communication means. Such data and communications may be received by a transceiver circuit 569 within the PRU 406. The transceiver 569 may transmit power demand requests or signals for configuring or modifying the transmit power level of the wireless field 205. In some aspects, the power demand requests may be based on the power supply capability of the PTU 402. For example, the PRU 406 may be placed close to or on the surface of the PTU 402 and the transceiver 569 may transmit a power demand request of >5 W (e.g., 10 W).

In some embodiments, the transceiver 532 may receive the power demand request and communicate the power demand request to the processor 522 via the bus 531. The processor 522 may then determine whether the power source 401 is capable of supplying an amount of power indicated in the power demand request (e.g., 10 W). In one aspect, the power source 401 may comprise a USB power source capable of supplying approximately 2.5 W. In such an example, the processor 522 may set a power level flag in the memory 524 to a “low” value to indicate that the power source 401 is capable of supplying a maximum of 2.5 W.

In response to receiving the power demand request from the transceiver 532, the processor 522 may determine that the power source 401 is not capable of supplying the 10 W requested in the power demand request. The processor 522, or the DSP 528 may then generate a request for the PRU 406 to adjust the power demand request based on the power level flag. For example, the request may indicate that the power source is capable of supplying a maximum of 2.5 W and may request that the PRU 406 adjust the power demand request to request no more than 2.5 W. The transceiver 532 may then transmit the generated request to the transceiver 569 of the PRU 406.

The PRU 406 may comprise a processor 562, one or more sensors 566, a DSP 568 and the transceiver 569 similar to the corresponding components of the PTU 402. The PRU 406 may further comprise a memory 564 similar to the memory 524, described above. Similar to the memory 524, the memory 564 may comprise both read-only memory (ROM) and random access memory (RAM), may provide instructions and data to the processor 562. A portion of the memory 564 may also include non-volatile random access memory (NVRAM).

The PRU 406 may also comprise the receiver 208 of FIG. 2 for receiving wireless power via the wireless field 205 from the transmitter 204 using the power receiving element 218. The receiver 208 may be operably connected to the processor 562, the memory 564, the sensor 566, UI 567 and DSP 568 via a bus 571, similar to the bus 531. Those of skill in the art will appreciate that the components of the PRU 406 may be coupled together or accept or provide inputs to each other using some other mechanism.

In some embodiments, in response to receiving the request to adjust the power demand request of the PRU 406, the transceiver 569 may communicate the request to the processor 562. The processor 562 may then adjust the power demand request to a power level within the capabilities of the power source 401 (e.g., ≦2.5 W). In some embodiments, the PRU 406 may comprise an impedance limiting circuit 565 operably connected to the processor 562 via the bus 571 and configured to limit an impedance (i.e., Z=V/I) of the receiver 208 and prevent a voltage collapse at the receiver 208. For example, the receiver 208 may be receiving 5 W of power (e.g., 5 volts (V) at a current (I) of 1 ampere (A), where P=IV) and the processor 562 may determine that it requires more current at the same 5 W power level. At a constant power, the increase in the current level reduces the voltage level and the impedance level. If the voltage level falls below a certain threshold, the receiver 208 may not be able to maintain a voltage level necessary for the generation of electromagnetic fields, leading to a voltage collapse. The impedance limiting circuit 565 may set an impedance limit or threshold such that the voltage level received does not fall below a minimum value and the current does not rise above a maximum value (e.g., Z_{Limit}=Vₘᵢₙ/Iₘₐₓ) to avoid such a voltage collapse. For example, in some aspects, the impedance limiting circuit 565 may lower the impedance of the receiver 208 as the current increases in order to keep the voltage level constant. In other aspects, the impedance limiting circuit 565 may raise the impedance of the receiver 208 as the voltage level increase in order to keep the current level constant. In other aspects, the impedance limiting circuit 565 may also communicate with the processor 562 to adjust the voltage level and/or the current level of the receiver 208 to keep an impedance level constant.

In some aspects, in addition to preventing voltage collapse, the impedance limiting circuit 565 may allow the receiver 208 to receive different power levels from the transmitter 204. For example, the processor 562 may adjust the impedance limit of the impedance limiting circuit 565 to allow for different power demands based on the power supply capability of the PTU 402. In particular, the processor 562, the controller 250 or the front-end circuit 232 may adjust the impedance limit (e.g., Vₘᵢₙ/Iₘₐₓ) to allow for the different power demands. For example, the receiver 208 may be receiving 2.5 W from the PTU 402 connected to a 2.5 W power source 401. The impedance limiting circuit 565 may set a first impedance limit for receiving power (e.g., Z_{Limit}=1V/2.5 A) from the PTU 402. The PTU 402 may then be connected to a 5 W power source 401 and may communicate to the PRU 406 its power supply capabilities (e.g., 5 W). In order to receive the 5 W from the PTU 402, the processor 562 may adjust the impedance limit to a second impedance limit (e.g., reduce to Z_{Limit}=1V/5 A) based on the increased power supply capabilities of the PTU 402. Accordingly, the processor 562 may then adjust the power demand so that the receiver 208 can receive 5 W. In addition, the processor 562 may adjust the impedance limit of the impedance limiting circuit 565 based on a decrease in the power supply capabilities of the PTU 402 or other charging parameters.

The processor 562, or DSP 568, may also generate an acknowledgment message in response to the request to adjust the power demand received from the transceiver 532 of the PTU 402. The acknowledgment message may include the adjusted power demand request requesting ≦2.5 W. The acknowledgment message may also include an acknowledgment of receiving the request to adjust power demand and an acknowledgment of the adjusted power demand request at a power level within the capabilities of the power source 401.

In some aspects, in response to receiving the acknowledgment message, the transceiver 532 may communicate the acknowledgment to the processor 522. The processor 522 may then signal to the transmitter 204 to begin transmitting power (e.g., 2.5 W) via the power transmitting element 214 and the magnetic field 205 to the power receiving element 218 of the PRU 406. In some aspects, the processor 522 may adjust a magnitude of the transmit current of the transmitter 204 in order to reach a more optimal PRU 406 voltage for wireless power transfer. For example, transmitter 204 may be capable of operating at a first transmit current level and a second transmit current level, where the second transmit current level is greater than the first transmit current level. Depending on the supply capabilities of the power source 401, the processor 522 may determine to operate at the first or second transmit current level. Additionally, the PRU 406 may communicate its optimal voltage to the PTU 402. Alternatively, as in the case of dedicated PRUs, the PTU 402 may have the optimal voltage for the PRU 406 pre-programmed or stored in the memory 524. In one example, the processor 522 may determine that it is connected to a dedicated PRU 406 and a 5 W supply and may select the first transmit current level to satisfy the PRU 406 power demand. In other embodiments, the processor 522 may determine that it is connected to a dedicated PRU 406 and a 1800 W supply (e.g., a wall outlet) and may select the second transmit current to satisfy the PRU 406 power demand. While only two transmit current levels are discussed above, the transmitter 204 may be capable of operating at more or fewer transmit current levels.

Additionally, after or in connection with transmitting the acknowledgment message, the processor 562 may allow the receiver 208 and/or power receiving element 218 to receive wireless power via the magnetic field 205. The receiver 208 may also transfer the power received to the battery 236 of FIG. 2 to charge or power the battery 236.

In some embodiments, the transceiver 532 and the transmitter 204 may share the power transmitting element 214. For example, in an aspect of an embodiment, the transceiver 532 may be configured to send data via modulation of the wireless field 205 used for transferring power. In another example the communication channel 219 is different than the wireless field 205, as shown in FIG. 5. In another example, the transceiver 532 and the transmitter 204 may not share the power transmitting element 214 and may each have their own antennas. Likewise, the transceiver 569 and the receiver 208 may share the power receiving element 218 and the transceiver 569 may be configured to receive data via modulation of the wireless field 205 used for transferring power. In other embodiments, the transceiver 569 and the receiver 208 may not share the power receiving element 218 and may each have their own antennas and the communication channel 219 is different than the wireless field 205.

The PRU 406 may further comprise a user interface (UI) 567 in some aspects. The user interface 567 may comprise a keypad, a microphone, a speaker, and/or a display. The user interface 567 may include any element or component that conveys information to a user of the PRU 406 and/or receives input from the user.

Although a number of separate components are illustrated in FIG. 5, those of skill in the art will recognize that one or more of the components may be combined or commonly implemented. For example, the processor 522 may be used to implement not only the functionality described above with respect to the processor 522, but also to implement the functionality described above with respect to the sensors 526 and/or the DSP 528. Likewise, the processor 562 may be used to implement not only the functionality described above with respect to the processor 562, but also to implement the functionality described above with respect to the sensor 566 and/or the DSP 568. Further, each of the components illustrated in FIG. 5 may be implemented using a plurality of separate elements.

Such implementations of wireless power transfer system 500 described above may be beneficial because they may prevent the PRU 406 overdrawing the power source 401. In such a case of overdrawing, the components of the PTU 402 and/or PRU 406 may be shut down or damage as a result of attempting to receive more power than the power source 401 is capable of providing. Accordingly, the wireless power transfer systems 100, 200, 400, and 500 may more efficiently transfer power and may reduce the instances of the PRU 406 overdrawing the power source 401.

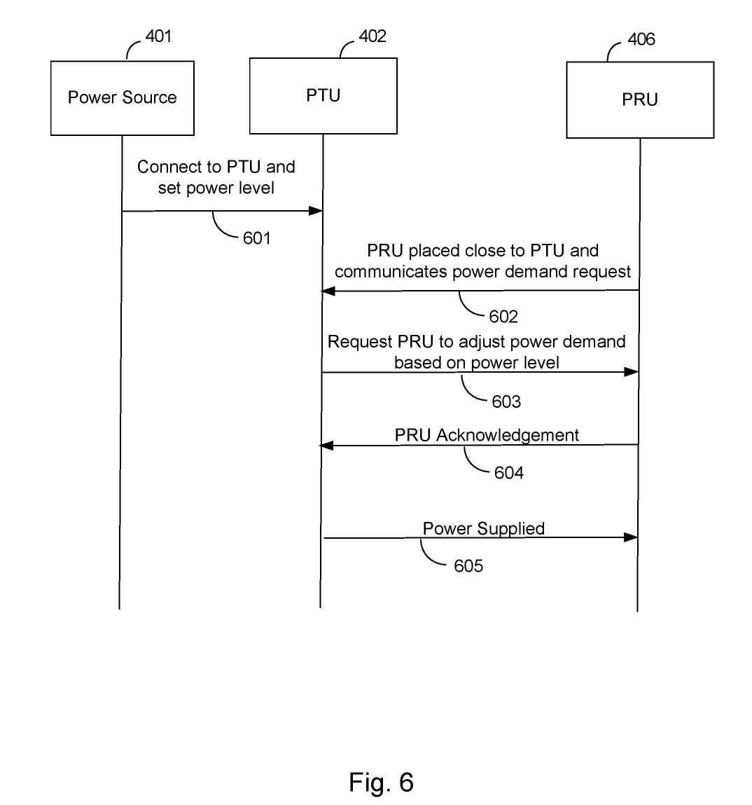

FIG. 6 is an exemplary flow diagram among the power source 401, the PTU 402, and the PRU 406. As shown in FIG. 6, the power source 401 may connect to the PTU 402 over the connection 601. The PTU 402 may detect the connection 601 from power source 401 and may set a power level of the power source 401. For example, in some embodiments, the power source 401 may comprise a USB power source or lower power source capable of providing between approximately 2.5 W and 5 W of power to the PTU 402. In some aspects, the PTU 402 may set one or more flags to indicate a power level supplied by the power source 401. For example, after the connection 601, the PTU 402 may determine that the power source 401 is a USB power source or other low power source (e.g., supplying ˜2.5-5 W) and may set a power level flag to “low.” In other embodiments, after the connection 601, the PTU 402 may determine that the power source 401 is a wall outlet or a high power source (e.g., supplying >5 W) and may set a power level flag to “high.”

As shown in FIG. 6, the PRU 406 may be placed close to or on the surface of the PTU 402 and may send a communication 602 including a power demand request. In some aspects, the PRU 406 may have one or more power settings for the power demand request. For example, the PRU 406 may have a first power setting for a first power demand request. The first power setting may be communicated to any PTU capable of transmitting power to the PRU 406. In some aspects, the first power setting may comprise a default power setting. Additionally, the PRU 406 may have a second power setting for a second power demand request which it may communicate to a single or dedicated PTU (e.g., PTU 402). In some aspects, the dedicated PTU 402 may be designed to work with a specific PRU (e.g., PRU 406) or with a type or brand of the PRU 406. In some embodiments, the PRU 406 may have a third power setting for a third power demand request which it may communicate to the dedicated PTU 402.

In some aspects, the first power setting may be based on an assumption that the PTU 402 is connected to a wall outlet or high power source (e.g., supplying >5 W). In some aspects, the second power setting may be based on a first power supply capability of the PTU 402 (e.g., supplying ˜5 W). In some aspects, the third power setting may be based on a second power supply capability of the PTU 402 (e.g., supplying ˜2.5 W). While three power settings are discussed above, it is possible for the PRU 406 to have more or fewer power settings having a variety of values.

In some embodiments, the communication 602 may also initiate a pairing process with the PTU 402. The pairing process may indicate that the PRU 406 and the PTU 402 are dedicated devices and designed to operate together in one or more configurations. Such configurations may allow the PRU 406 to adjust its power settings (e.g., power demand requests) to receive power from the PTU 402 at a level within the PTU's 402 power supply capabilities (e.g., ˜2.5-5 W). In some aspects, the communication 602 may include an indication that the PRU 406 is a dedicated PRU for charging with the PTU 402.

After receiving the communication 602 from the PRU 406, the PTU 402 may determine whether it is capable of fulfilling the power demand request of the communication 602. In some embodiments, the PTU 402 may make this determination based on the power level flag set in response to the connection 601. For example, the PRU 406 power demand request may request over 5 W of power from the PTU 402. In some aspects, the PTU 402 may have set a power level flag to “low” in response to the connection 601 indicating that the power source 401 is a low power or USB power source. In such an embodiment, the PTU 402 may determine it is not capable of fulfilling the PRU 406 power demand request (e.g., >5 W) based on the power level flag (e.g., “low”). The PTU 402 may then send communication 603 to the PRU 406 requesting the PRU 406 to adjust the power demand request. In some aspects, the PTU 402 may also identify the PRU 406 as a dedicated PRU for charging with the PTU 402 based on the communication 602.

After receiving the communication 603 from the PTU 402, the PRU 406 may adjust a power setting for the power demand request based on the communication 603. For example, the communication 603 may include a request for the PRU 406 to lower the power level of the power demand request. Based on the request, the PRU 406 may adjust the power demand request. In some embodiments, the processor 562 may adjust the power demand by adjusting the impedance limit of the impedance limiter 565.

Additionally, the PRU 406 may adjust the power demand by adjusting certain voltage thresholds of the receiver 208. For example, the receiver 208 may have a minimum voltage level, a maximum voltage level, and a set or operating voltage level. In some aspects, the set or operating voltage level indicates a desired voltage level. In some aspects, the processor 562 may determine that the PRU 406 operates more efficiently at a different operating voltage level depending on the PTU 402 power supply. In one example, the processor 562 may determine that the PTU 402 can supply 5 W and that the PRU 406 operates more efficiently at 5V, but at a 2.5 W power supply, the PRU 406 operates more efficiently at 2.5V. Accordingly, the processor 562 may change the operating voltage level of the PRU 406 and/or other voltage thresholds to accomplish more efficient wireless power transfer. In some aspects, the PRU 402 or transceiver 569 may communicate the operating voltage level to the transceiver 532. In response, the processor 522 may adjust the transmit current level discussed above to more closely match the PRU 406 operating voltage level.

In some aspects, the PTU 402 request may include an indication of the power supply capability of the PTU 402 and the PRU 406 may adjust the power demand request such that it requests a power level within the power supply capability of the PTU 402. In one aspect, the PTU 402 may indicate in the communication 603 that it is capable of supplying 2.5 W to the PRU 406 (e.g., power level flag set to “low”). In response, the PRU 406 may adjust is power setting from the first power setting described above (e.g., >5 W), or from the second power setting (e.g., ˜5 W), to the third power setting (e.g., ˜2.5 W) for the power demand request. The PRU 406 may then send an acknowledgement 604 indicating it has adjusted the power setting (e.g., ˜2.5 W) for the power demand request. The PRU 406 may make this determination and adjustment of the power setting prior to enabling its charge port.

After receiving the acknowledgement 604, the PTU 402 may supply power 605 to the PRU 406 based on the adjusted power setting (e.g., ˜2.5 W). Additionally, the PRU 406 may then allow its charge port to begin receiving power from the PTU 402. Accordingly, a non-limiting benefit of the PRU 406 adjusting the power setting for the power demand requests based on the PTU 402 power supply capabilities is that it reduces or eliminates situations where the PRU 406 overdraws the PTU 402 and causes disconnections or shut downs of power transfer. Additionally, by pairing a particular PTU 402 with a particular PRU 406, the PTU 402 and PRU 406 may be configured to exchange information to facilitate more efficient power transfer.

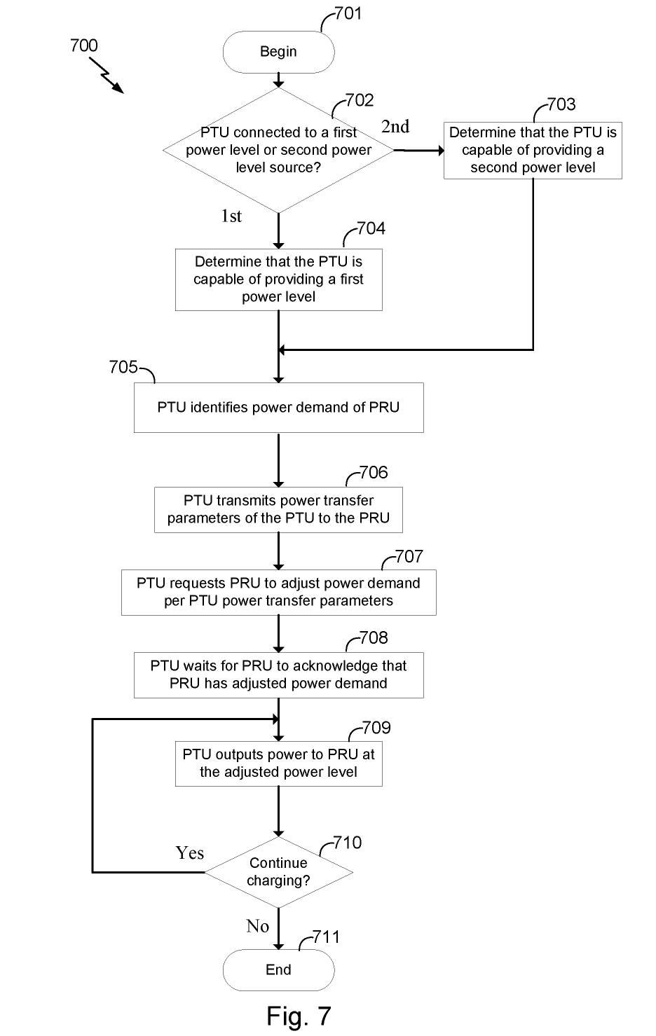

FIG. 7 is a flowchart of an exemplary method 700 of receiving wireless power, in accordance with one embodiment. The method shown in FIG. 7 may be implemented via one or more devices including transmitter 104, the receiver 108, the power transmitting element 114, the power receiving element 118, the power transmitting element 214, the power receiving element 218, the transmit or receive circuitry 350, the PTU 402, the PRU 406, and the PRU 408 of FIGS. 1-6. Although the method 700 is described herein with reference to a particular order, in various implementations, blocks herein may be performed in a different order, or omitted, and additional blocks may be added.

At block 701, the method begins when the PTU 402 connects to the power source 401. At block 702, the processor 522 determines whether the PTU 402 is connected to a first power level or a second power level power source. This determination is based on a power level capability of the power source 401. In one example, the processor 522 may check to see whether a first power level flag goes high or whether the sensors 526 indicate the power source 401 is capable of providing a first power level. In some aspects, the first power level may be a power level greater than 5 W. The determination may also be communicated to the PTU 402 and received by the transceiver 532. If the processor determines the PTU 402 is connected to the first power level, at block 704, the processor 522 sets a power level flag to indicate that the PTU 402 is capable of providing the first power level. In some embodiments, the power level flag comprises a second power level flag that is set to “high.” If the first power level flag described above does not go high, or the sensors 526 indicate the power source 401 is capable of providing a second power level, at block 703, the processor 522 sets a power level flag (e.g., the second power level flag) to indicate that the PTU 402 is capable of providing the second power level. In some aspects, the first power level is greater than the second power level. For example, the second power level may be between approximately, 2.5-5 W. In some embodiments, the power level flag comprises the second power level flag that is set to “low.”

At block 705, the PRU 406 is placed close to or on a surface of the PTU 402. In some aspects, the PRU 406 is a dedicated PRU and the PTU 402 may identify power transfer parameters of the PRU 406 and may identify the PRU 406 as a dedicated PRU based on the placement. In some embodiments, the PRU 406 communicates its dedicated status and power transfer parameters to the PTU 402 over transceiver 569. In other embodiments, the sensors 526 or the processor 522 determines the PRU 406 is dedicated based on characteristics or charging parameters detected by the sensors 526. Additionally, the PRU 406 may communicate a power demand requesting a power level from the PTU 402. In some embodiments the PRU 406 power transfer parameters comprise a power demand requesting a power level from the PTU 402. In some aspects, the transceiver 569 communicates to the transceiver 532 the power demand request. The transceiver 532 receives the power demand request and the processor 522 may identify the PRU 406 as a dedicated PRU. At block 706, PTU 402 communicates its power transfer parameters to the PRU 406. In some aspects, the PTU 402 power transfer parameters include the power supply capability of the transmitter 204 (e.g., 2.5 W or 5 W). In some embodiments, the PTU 402 identifies itself to the PRU 406 as a dedicated PTU. The PTU 402 may communicate the power transfer parameters and dedicated status using the transmitter 204 or the transceiver 532. As discussed above, the communication in blocks 705 and 706 may be part of a pairing process that allows the PTU 402 and PRU 406 to adjust power transfer parameters (e.g., power level transferred).

At block 707, the PTU 402 requests the PRU 406 to adjust the power demand request based on the power level flag set above in either block 703 or 704. In some aspects, the PTU 402 communicates this request prior to receiving a power demand from the PRU 406. In other embodiments, the processor 522 determines that the power level of a power demand request sent by the PRU 406 exceeds the power level capability of the power source 401. The determination may be based on whether the power level flag (e.g., the second power level flag described above) is set to high or low. If the first power level exceeds the power level capability of the power source 401, then the processor 522 or the DSP 528 may generate a request for the PRU 406 to adjust the power demand request to request a power level within the power level capability of the power source 401.

In one example, the PRU 406 may have three power demand settings (e.g., Prect_Max settings) requesting three different power levels. The first setting, e.g., A4WP Prect_Max, requests the highest power level and may comprise the power demand the PRU 406 communicates to any PTU that is capable of charging the PRU 406. The second setting, e.g., Prect_Max dedicated 1, requests a next highest power level and may comprise a power demand the PRU 406 communicates to a dedicated PTU configured to operate with the PRU 406. The third setting, e.g., Prect_Max dedicated 2, requests the lowest power level and may also comprise a power demand the PRU 406 communicates to a dedicated PTU configured to operate with the PRU 406. In some embodiments, PTU 402 generated request instructs the PRU 406 to adjust a Prect_max setting of the PRU 402 (e.g., to one of the three power settings). For example, if the processor 522 determines the PTU 402 is capable of providing the second power level (e.g., 2.5 W as described with respect to block 703) and that the PRU 406 is a dedicated PRU, then the PTU 402 may request for the PRU 406 to adjust the power demand setting to Prect_Max dedicated 2.

At block 708, the PTU 402 waits for the PRU 406 to acknowledge the request to adjust the PRU 406 power demand. In some aspects, the acknowledgment includes an indication that the processor 562 has adjusted the Prect_max setting to a power level within the power level capability of the power source 401 (e.g., Prect_Max dedicated 2). At block 709, the PTU 402 receives the acknowledgment from the PRU 406 and outputs or provides power to the PRU 406 at the adjusted power level. At block 710, the processor 522 determines whether to continue charging. If yes, then the process returns to block 709. If no, the process ends at block 711 and the PTU 402 stops charging the PRU 406.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the embodiments of the present disclosure.

The various illustrative blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and blu ray disc where disks usually reproduce data magnetically, while discs reproduce data optically with lasers. Combinations of the above should also be included within the scope of computer readable media. The processor and the storage medium may reside in an ASIC. The ASIC may reside in a user terminal. In the alternative, the processor and the storage medium may reside as discrete components in a user terminal.

For purposes of summarizing the disclosure, certain aspects, advantages and novel features of the present disclosure have been described herein. It is to be understood that not necessarily all such advantages may be achieved in accordance with any particular embodiment of the present disclosure. Thus, the present disclosure may be embodied or carried out in a manner that achieves or optimizes one advantage or group of advantages as taught herein without necessarily achieving other advantages as may be taught or suggested herein.

Various modifications of the above described embodiments will be readily apparent, and the generic principles defined herein may be applied to other embodiments without departing from the spirit or scope of the present disclosure. Thus, the present application is not intended to be limited to the embodiments shown herein but is to be accorded the widest scope consistent with the principles and novel features disclosed herein.

What is claimed is:

1. An apparatus for wirelessly transmitting power to a wireless power receiver, the apparatus comprising:
a transmitter circuit configured to transmit wireless power via a magnetic field sufficient to power or charge the wireless power receiver;
a processor circuit configured to determine a power level capability of the transmitter circuit; and
a communication circuit configured to transmit a first communication to the wireless power receiver, the first communication including a request to adjust a power demand of the wireless power receiver from a first power level to a second power level, the first power level being higher than the second power level, wherein the second power level is commensurate with the power level capability of the transmitter circuit.

2. The apparatus of claim 1, wherein the power level capability is based on a power supply capability of a power source coupled to the transmitter circuit.

3. The apparatus of claim 2, further comprising a sensor circuit configured to determine whether the power source is capable of providing the first power level or the second power level.

4. The apparatus of claim 1, wherein the communication circuit is further configured to receive a second communication from the wireless power receiver, the second communication including the power demand at the first power level.

5. The apparatus of claim 1, wherein the communication circuit is further configured to transmit the first communication when the power level capability corresponds to a power level below the first power level.

6. The apparatus of claim 1, wherein the second power level corresponds to a power level equal to or below the power level capability of the transmitter circuit.

7. The apparatus of claim 1, wherein the processor circuit is further configured to adjust a current level of the transmitter circuit based on the power level capability of the transmitter circuit.

8. The apparatus of claim 1, wherein the communication circuit is further configured to receive a second communication from the wireless power receiver in response to the first communication, the second communication including the power demand at the second power level.

9. A method for wirelessly transmitting power to a wireless power receiver, comprising:
transmitting, from a wireless power transmitter, wireless power via a magnetic field sufficient to power or charge the wireless power receiver;
determining a power level capability of the wireless power transmitter; and
transmitting a first communication to the wireless power receiver, the first communication including a request to adjust a power demand of the wireless power receiver from a first power level to a second power level, the first power level being higher than the second power level, wherein the second power level is commensurate with the power level capability of the wireless power transmitter.

10. The method of claim 9, wherein the power level capability is based on a power supply capability of a power source coupled to the wireless power transmitter.

11. The method of claim 10, further comprising determining whether the power source is capable of providing the first power level or the second power level.

12. The method of claim 9, further comprising receiving a second communication from the wireless power receiver, the second communication including the power demand at the first power level.

13. The method of claim 9, wherein transmitting the first communication comprises transmitting the first communication when the power level capability corresponds to a power level below the first power level.

14. The method of claim 9, wherein the second power level corresponds to a power level equal to or below the power level capability of the wireless power transmitter.

15. The method in claim 9, further comprising adjusting a current level of the wireless power transmitter based on the power level capability of the wireless power transmitter.

16. The method of claim 9, further comprising receiving a second communication from the wireless power receiver in response to the first communication, the second communication including the power demand at the second power level.

17. An apparatus for wirelessly transmitting power to a wireless power receiver, the apparatus comprising:
means for transmitting wireless power via a magnetic field sufficient to power or charge the wireless power receiver;
means for determining a power level capability of the means for transmitting wireless power; and
means for transmitting a first communication to the wireless power receiver, the first communication including a request to adjust a power demand of the wireless power receiver from a first power level to a second power level, the first power level being higher than the second power level, wherein the second power level is commensurate with the power level capability of the means for transmitting wireless power.

18. The apparatus of claim 17, further comprising means for providing power to the means for transmitting wireless power, wherein the power level capability is based on a power supply capability of the means for providing power.

19. The apparatus of claim 18, further comprising means for determining whether the means for providing power is capable of providing the first power level or the second power level.

20. The apparatus of claim 17, further comprising means for receiving a second communication from the wireless power receiver, the second communication including the power demand at the first power level.

21. The apparatus of claim 17, wherein the means for transmitting a first communication is configured to transmit the first communication when the power level capability corresponds to a power level below the first power level.

22. The apparatus of claim 17, wherein the second power level corresponds to a power level equal to or below the power level capability of the transmitter circuit.

23. The apparatus of claim 17, further comprising means for adjusting a current level of the means for transmitting wireless power based on the power level capability of the transmitting means.

24. The apparatus of claim 17, further comprising means for receiving a second communication from the wireless power receiver in response to the first communication, the second communication including the power demand at the second power level.

25. A non-transitory computer readable storage medium comprising instructions that, when executed by a processor, causes a wireless power transmitter to:
transmit, from a wireless power transmitter, wireless power via a magnetic field sufficient to power or charge the wireless power receiver;
determine a power level capability of the wireless power transmitter; and
transmit a first communication to the wireless power receiver, the first communication including a request to adjust a power demand of the wireless power receiver from a first power level to a second power level, the first power level being higher than the second power level, wherein the second power level is commensurate with the power level capability of the wireless power transmitter.

26. The medium of claim 25, wherein the power level capability is based on a power supply capability of a power source coupled to the wireless power transmitter.

27. The medium of claim 26, wherein the instructions are further configured to cause the wireless power transmitter to determine whether the power source is capable of providing the first power level or the second power level.

28. The medium of claim 25, wherein the instructions are further configured to cause the wireless power transmitter to receive a second communication from the wireless power receiver, the second communication including the power demand at the first power level.

29. The medium of claim 25, wherein the transmission of the first communication occurs when the power level capability corresponds to a power level below the first power level.

30. The medium of claim 25, wherein the instructions are further configured to cause the wireless power transmitter to adjust a current level of the wireless power transmitter based on the power level capability of the wireless power transmitter.
